(19) United States
(12) Patent Application Publication
(10) Pub. No.: US 2010/0032056 A1
(43) Pub. Date: Feb. 11, 2010

(54) ROTARY FILLING MACHINE

(75) Inventor: Damien LeBras, Octeville sur Mer (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: SIDEL PARTICIPATIONS, Octeville sur Mer (FR)

(21) Appl. No.: 12/444,245

(22) PCT Filed: Oct. 2, 2007
(86) PCT No.: PCT/FR2007/001604

§ 371 Date: Apr. 3, 2009

(30) Foreign Application Priority Data
Oct. 5, 2006 (FR) 0608733

(51) Int. Cl. B67C 3/20

(52) U.S. Cl. 141/242; 141/284

(57) ABSTRACT

The invention relates to a rotary container-filling machine comprising a rotary annular tank for storing the filling product, a number of filling stations, each filling station comprising a filling spout connected to the annular tank and metering means, said metering means comprising a valve system positioned in the region of the filling spout and valve control means mounted in the upper part of the annular tank to open and close the valve system, using control cables extending towards the hollow central region of the annular tank and annular tank supply means comprising at least one fixed feed tube positioned between the valve control means of the filling stations and the exterior side wall of the annular tank.

### PRIORITY CLAIM

The present application is a National Phase entry of PCT Application No. PCT/FR2007/001604, filed Oct. 2, 2007, which claims priority from French Application Number 0608733, filed Oct. 5, 2006, the disclosures of which are hereby incorporated by reference herein in their entirety.

### TECHNICAL FIELD

The present invention relates to a rotary machine for filling hollow containers, such as bottles or pots, with a food product, more particularly a filling liquid such as water, milk, oil or fruit juice. More particularly, the present invention relates to a rotary filling machine comprising an annular tank for the storage of the filling product.

### BACKGROUND

Such rotary filling machines typically comprise a rotary carrousel bearing an annular tank and a number of filling stations, each filling station comprising a filling spout connected to the tank, and metering means for dispensing a determined quantity of filling product into each container. The metering means comprise a valve system positioned in the region of the filling spout and valve control means to controllably open and close the valve system. These control means are mounted on the upper part of the annular tank using control cables extending towards the hollow central region of the annular tank for plugging them to a controller.

The filling product supply means of this type of tank typically comprise one main vertical fixed tube extending in the hollow central region according to the rotational axis of the tank and connected on the lower end via a swivel joint to one or more secondary tubes in fluid communication with the annular tank, said secondary tubes in rotation along with the latter.

Such annular tanks enable to propose rotary machines with an increased number of filling stations, while limiting the tank capacity. However, their supply system with swivel joint has a complex conception and a delicate maintenance, and proves to be difficult to clean.

### SUMMARY

Embodiments of the invention propose a rotary filling machine overcoming the aforesaid drawbacks, of simple conception and easily cleanable.

To this end, an embodiment of the invention is a rotary container-filling machine comprising-a rotary annular tank for storing filling product,-a plurality of filling stations, each filling station including a filling spout connected to the annular tank and metering means, said metering means comprising a valve system disposed at the filling spout and valve control means mounted on the upper part of the annular tank to controllably open and close the valve system, with control cables extending from said controlling means towards the hollow central region of the annular tank, and annular tank supply means, wherein the supply means comprise at least one fixed feed tube, independent from the tank, not contacting it, disposed between the valve control means of the filling stations and the exterior side wall of the annular tank.

According to embodiments of the invention, a feed tube is fixedly mounted on a support member independent from the rotary tank, so as to extend substantially vertically between the exterior side wall of the tank and the valve control means, without hindering the rotation of the valve control means secured to the rotary tank. For a same number of filling stations as a conventional machine, and identical metering means, it may be necessary to slightly enlarge the tank for positioning the fixed feed tube. Such a feed tube has a particularly simple conception and easy maintenance. Furthermore, the tank capacity can easily be adapted to the nature of the filling product and to the number of filling stations by selecting the correspondent spacing between the interior side wall of the tank and the rotational axis of the machine.

The fixed feed tube is of rectangular or circular transversal section. A rectangular section in one embodiment limits its space requirement.

According to an embodiment, the filling spouts are mounted on the bottom wall of the annular tank, the valve system being formed by a valve mounted at the free end of the stem of a jack, said jack, being pneumatic in one embodiment, constituting said valve control means.

Advantageously, the upper opening of the tank is covered by first protection means secured to the tank and second fixed protection means, not contacting the tank.

### BRIEF DESCRIPTION OF THE DRAWINGS

The invention will be better understood, and other details, characteristics and advantages will become more apparent in the following detailed explanatory description of a currently-preferred particular embodiment of the invention, with reference to the accompanying schematic drawing, where:

FIG. 1 depicts a schematic cross-sectional view of half a rotary filling machine according to the invention; and,

FIG. 2 depicts a partial schematic top view of the machine of FIG. 1.

### DETAILED DESCRIPTION

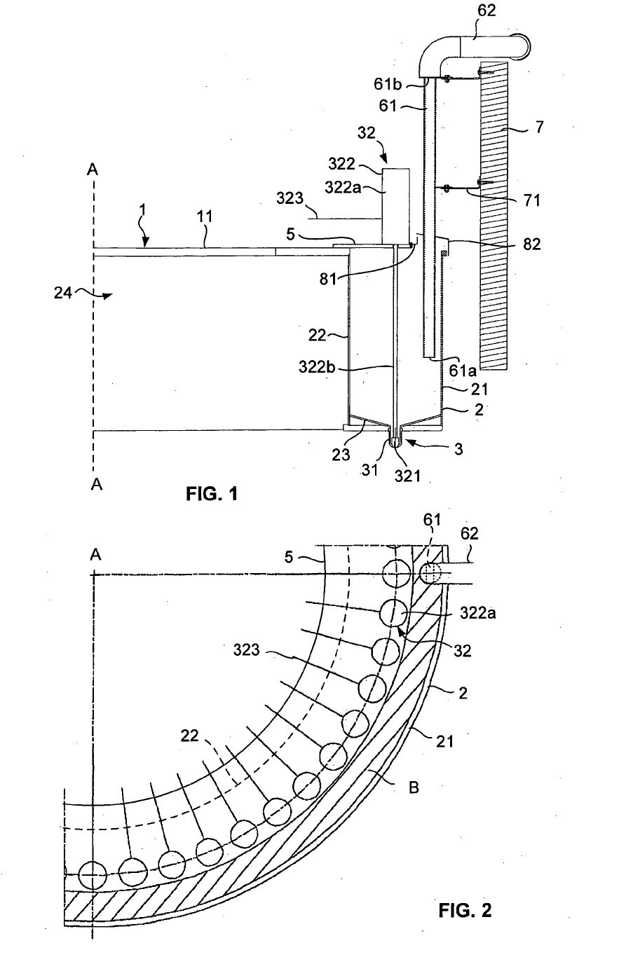

With reference to the drawings, the rotary machine comprises a carrousel 1, represented only schematically on FIG. 1, including a support structure 11 intended to be rotationally mounted on a fixed frame (not shown) around a vertical rotational axis A. The carrousel 1 bears an annular tank 2 of filling liquid, equipped with a plurality of filling stations 3 disposed at regular angle space around the rotational axis.

The annular tank 2 of axis A comprises an exterior cylindrical side wall 21, also called peripheral wall, an interior cylindrical side wall 22 and a bottom wall 23, said walls defining all together a volume for storing a filling liquid. The annular tank is fixed upon the support structure 11 by its interior side wall, for example proximate the upper edge.

Each filling station 3 comprises a filling spout 31 vertically mounted on the bottom wall 23 of the filling tank, with a discharge orifice, oriented downwards, in fluid communication with the filling tank. The spouts are for example disposed equidistant to the side walls of the tank, such as illustrated in FIG. 1.

Each station further comprises a container support system (not shown) for supporting and holding a container, such as a bottle, under the filling spout. This support system comprises for example a gripper system for grasping a bottle and a base for supporting the bottle from its bottom.

The product metering means 32 are associated with each filling spout to dispense a determined quantity of product into each container brought under the filling spout. These metering means comprise a valve 321 positioned in the filling spout and controlled to open and close by a pneumatic jack 322 arranged above the tank. The body 322a of the jack is mounted on a support plate 5 pertaining to each jack body 332a (not shown) or on one unique annular support plate 5 assembled to the support structure 11, its stem 322b substantially vertically extends into the tank and bears the valve at its free end, such that the valve may be moved vertically in translation by the jack to open or close the discharge orifice.

As represented schematically on the drawings, the electrical cables 323 for controlling the jacks are brought towards the hollow central region 24 delimited by the interior side wall 22 of the tank, where they will be regrouped to be connected to a controller mounted for example in the hollow central region. The metering means are for example weight-based, the jack being servo-controlled by a weighing sensor placed in the region of the support system, for example at the aforementioned base. Alternatively, the jack is servo-controlled by a sensor detecting the filling level of the container or a flow meter to be intercalated between the container and the spout upon filling.

The bodies 322a of the jacks are arranged above the tank such as to keep a free annular sector between said jacks and exterior side wall 21, represented by the hatched area B on FIG. 2, to allow the passing of a fixed feed tube 61, hollow and straight. This filling tube has a rectangular section in one embodiment, such as it appears on FIG. 2, in order to limit the required space for its positioning with no contact between the exterior side wall and the jacks. This feed tube is mounted via brackets 71 on a fixed support member 7, which is, for example, secured to the fixed framework of the carrousel. The feed tube extends vertically into the tank, proximate to the exterior side wall and parallel to it. Its lower end 61a is disposed in the tank above the bottom wall 23, for example, at mid-depth, and the tube is connected by its upper end 61b, via ducts 62, to a source of filling product (not shown). In operation, the annular tank is driven in rotation whereas the feed tube remains stationary between the exterior side wall 21 of the tank and the jacks 322 of the filling stations.

As shown in FIG. 1, in order to protect from the outside the product inside the tank, the support plate 5 for the jacks partially covers the tank, and the free annular sector is covered by a first ring 81, fixed to the support plate, exhibiting an external vertical rim directed upwards and disposed at a distance from the feed tube, and a second ring 82, fixedly mounted, not contacting the tank, like the feed tube, by appropriate fixing means, this second ring exhibiting an external

1. A rotary container-filling machine comprising
a rotary annular tank for storing filling product;
a plurality of filling stations, each filling station including a filling spout connected to the annular tank; and
metering means, comprising a valve system disposed at the filling spout and valve control means mounted on an upper part of the annular tank to controllably open and close the valve system, with control cables extending towards a hollow central region of the annular tank, and annular tank supply means, wherein the supply means comprise at least one fixed feed tube disposed between the valve control means of the filling stations and an exterior side wall of the annular tank.

2. The machine according to claim 1, wherein the fixed feed tube has a rectangular section.

3. The machine according to claim 1, wherein the filling spouts are mounted on a bottom wall of the annular tank, and the valve system is formed by a valve mounted at a free end of a stem of a jack, the jack comprising the valve control means.

4. The machine according to claim 1, wherein an upper opening of the tank is covered by first protection means secured to the tank and second fixed protection means not contacting the tank.
